(19) United States
(12) Patent Application Publication
(10) Pub. No.: US 2019/0121630 A1
(43) Pub. Date: Apr. 25, 2019

(54) NUMERICAL CONTROLLER

(71) Applicant: FANUC CORPORATION, Minamitsuru-gun (JP)

(72) Inventor: Katsuhiro Endou, Minamitsuru-gun (JP)

(73) Assignee: FANUC CORPORATION, Minamitsuru-gun (JP)

(21) Appl. No.: 16/160,220

(22) Filed: Oct. 15, 2018

(30) Foreign Application Priority Data
Oct. 23, 2017 (JP) 2017-204189

(51) Int. Cl. G06F 8/61; G05B 19/408

(52) U.S. Cl. CPC G06F 8/62; G05B 2219/31288; G05B 19/408

(57) ABSTRACT

A numerical controller is configured to be able to automatically extract a machining program of a deletion candidate and includes: a storage period designating unit that sets a storage period of a machining program; a use date recording unit that records a date on which the machining program is used; a deletion candidate selecting unit that extracts the machining program of the deletion candidate based on the storage period and the use date; and a deleting unit that deletes the machining program of the deletion candidate.

### BACKGROUND OF THE INVENTION

### 1. Field of the Invention

The present invention relates to a numerical controller. More particularly, the present invention relates to a numerical controller which can automatically extract deletion candidate machining programs.

### 2. Description of the Related Art

A machining program is necessary when a machine tool (hereinafter just referred to as machine) controlled by a numerical controller machines a workpiece. The machining program is generally stored in a non-volatile memory of the numerical controller.

To perform various types of machining, an operator uses an editing function of the numerical controller to add or correct machining programs. As a result, multiple machining programs are accumulated in the non-volatile memory of the numerical controller, and new machining programs cannot be added in some cases.

In this case, the operator mainly manually finds an unnecessary machining program from the machining programs stored in the non-volatile memory to delete, and secures an empty space of the non-volatile memory. However, the operator requires a great effort to find the unnecessary machining program from a great number of (typically, several hundreds or more of) machining programs stored in the non-volatile memory.

A method for securing a space in the non-volatile memory which stores the machining programs of the numerical controller includes a memory condense function of organizing data in the memory and securing the space. Furthermore, there is a method for backing up, in an external storage device, data of machining programs in the non-volatile memory, and then deleting the machining programs in the non-volatile memory.

Furthermore, methods for efficiently managing machining programs stored in non-volatile memories of numerical controllers are disclosed in Japanese patent documents, such as JP 11-202917 A, JP 2009-070268 A, JP 3563793 B2 and JP 2001-273252 A. JP 11-202917 A discloses the method for designating a machining unit name, and deleting a machining data group from the memory of the numerical controller. JP 2009-070268 A discloses the method for extracting a backup file from control data and a designated file stored in a storage unit of the numerical controller. JP 3563793 B2 discloses a method for sequentially deleting emulation data stored in the memory of a printer in the order of dates or in the order of days on which the emulation data is used, starting from the oldest. JP 2001-273252 A discloses a method for managing content of a web server, which uses means for deleting a web content for which a predetermined period has elapsed.

However, machining program data is not a deletion target in a case of the memory condense function of the non-volatile memory, and therefore a memory space which can be secured is limited.

Furthermore, an operation of backing up in the external storage device the machining programs in the non-volatile memory is bothersome and takes a time, backed-up data includes unnecessary machining programs, and therefore fundamental solutions cannot be obtained.

JP 11-202917 A, JP 2009-070268 A, JP 3563793 B2 and JP 2001-273252 A disclose the methods for efficiently managing machining programs (or other data) stored in the non-volatile memories and used for machining. However, none of these documents discloses a method for accurately and efficiently extracting a machining program which is likely to be a deletion candidate among machining programs in the non-volatile memories, in other words, an unnecessary machining program.

### SUMMARY OF THE INVENTION

The present invention has been made to solve such a problem. An object of the present invention is to provide a numerical controller which can automatically extract deletion candidate machining programs.

A numerical controller according to one embodiment of the present invention includes: a storage period designating unit that sets a storage period of a machining program; a use date recording unit that records a date on which the machining program is used; a deletion candidate selecting unit that extracts the machining program of a deletion candidate based on the storage period and the date on which the machining program is used; and a deleting unit that deletes the machining program of the deletion candidate.

The date on which the machining program is used may be a date on which the machining program is lastly inputted, edited or executed, or may be a date on which the machining program is inputted, edited or executed first.

The deletion candidate selecting unit may extract the machining program of the deletion candidate when the machining program is newly inputted or edited.

According to the present invention, it is possible to provide a numerical controller which can automatically extract deletion candidate machining programs.

### BRIEF DESCRIPTION OF THE DRAWINGS

The forgoing and other objects and feature of the invention will be apparent from the following description of preferred embodiments of the invention with reference to the accompanying drawings, in which:

FIG. 1 is a block view illustrating a configuration of a numerical controller;

FIG. 2 is a block diagram illustrating a configuration of one embodiment of the numerical controller;

FIG. 3 is a flowchart illustrating the operation according to the embodiment of the numerical controller;

FIG. 4 is a flowchart illustrating an operation according to the embodiment of the numerical controller;

FIG. 5 is a flowchart illustrating the operation according to the embodiment of the numerical controller;

FIG. 6 is a flowchart illustrating the operation according to the embodiment of the numerical controller; and

FIG. 7 is a flowchart illustrating the operation according to the embodiment of the numerical controller.

### DETAILED DESCRIPTION OF THE PREFERRED EMBODIMENTS

A numerical controller 100 according to an embodiment of the present invention will be described with reference to the drawings.

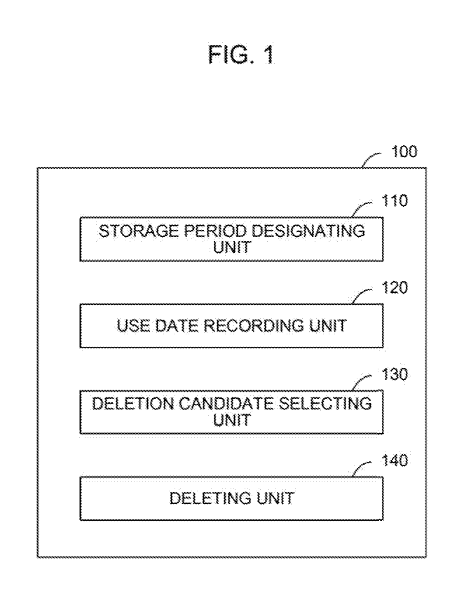

FIG. 1 is a block view illustrating a functional configuration of the numerical controller 100. The numerical controller 100 includes a storage period designating unit 110, a use date recording unit 120, a deletion candidate selecting unit 130 and a deleting unit 140. The numerical controller 100 includes an unillustrated CPU, storage device and input/output device which are not illustrated, and the CPU executes programs stored in the storage device to logically realize each processing unit.

The storage period designating unit 110 sets a storage period of each machining program. For example, the storage period designating unit 110 can provide a user interface which sets the storage period to each machining program. The storage period may be arbitrarily settable. Alternatively, the storage period designating unit 110 may be configured to select an optional storage period from options such as one day, one week, one month, six months, one year and permanence (i.e., a machining program not selected as a deletion candidate). In case of, for example, a machining program for a machining test, a short storage period (e.g., in units of days or weeks) is generally set. On the other hand, in a case of a machining program for maintenance, a long (e.g., permanent) storage period is generally set.

Furthermore, the storage period designating unit 110 may set a storage period default value to machining programs to which a user does not set storage periods. The storage period default value is preferably set short (e.g., in units of days or weeks) generally. Each machining program is edited over and over in a machining process, and each machining program before editing is not less likely to be used as is. Furthermore, each edited program completed as a result of trial and error is usually used for machining continually thereafter. Assuming this case, the storage period which is set short is useful as a condition for extracting a machining program which is no longer used.

The use date recording unit 120 records a date on which each machining program is used. The use date of each machining program includes, for example, a date on which each machining program is inputted, a date on which each machining program is executed (i.e., machining is performed by using each machining program) and a date on which each machining program is edited. The use date recording unit 120 typically records a date on which each machining program is lastly used, yet may record a date on which each machining program is used first.

By recording the date on which each machining program is lastly used, it is possible to extract each machining program whose elapsed time from the last use date exceeds the storage period. For example, this method is suitable to a machining program which is edited in the machining process. On the other hand, by recording the date on which each machining program is used first, it is possible to extract each machining program whose elapsed time from start of use exceeds the storage period. This method is suitable to, for example, a machining program which is used for a product produced for a limited period of time.

The deletion candidate selecting unit 130 extracts as a deletion candidate a machining program whose elapsed time from a use date of this machining program to the present exceeds the storage period. The deleting unit 140 deletes the machining program extracted by the deletion candidate selecting unit 130.

For example, the deletion candidate selecting unit 130 can extract deletion candidate machining programs at every constant time, and the deleting unit 140 can automatically delete the extracted machining programs. Alternatively, the deletion candidate selecting unit 130 may extract deletion candidate machining programs according to a user's instruction or a predetermined trigger at every constant time to present (typically display) to the user, and the deleting unit 140 may delete the machining program selected by the user.

### EXAMPLE

The example will describe the numerical controller 100 which extracts a deletion candidate machining program based on the number of elapsed days from a day on which the machining program is lastly used.

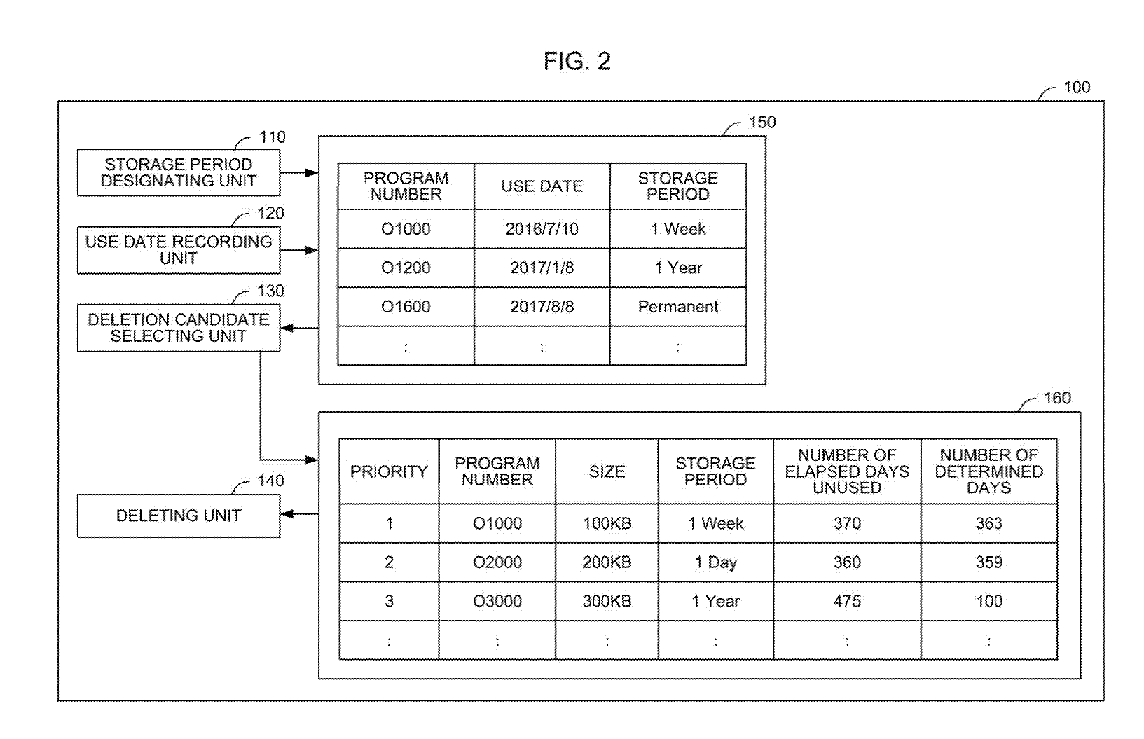

FIG. 2 is a block diagram illustrating an outline of a functional configuration of the numerical controller 100 according to the example.

The numerical controller 100 includes a storage period designating unit 110, the use date recording unit 120, the deletion candidate selecting unit 130 and the deleting unit 140 and, in addition, a use status management table 150 which manages a use date and a storage period of a machining program. Furthermore, a machining program group extracted by the deletion candidate selecting unit 130 is a deletion candidate list 160.

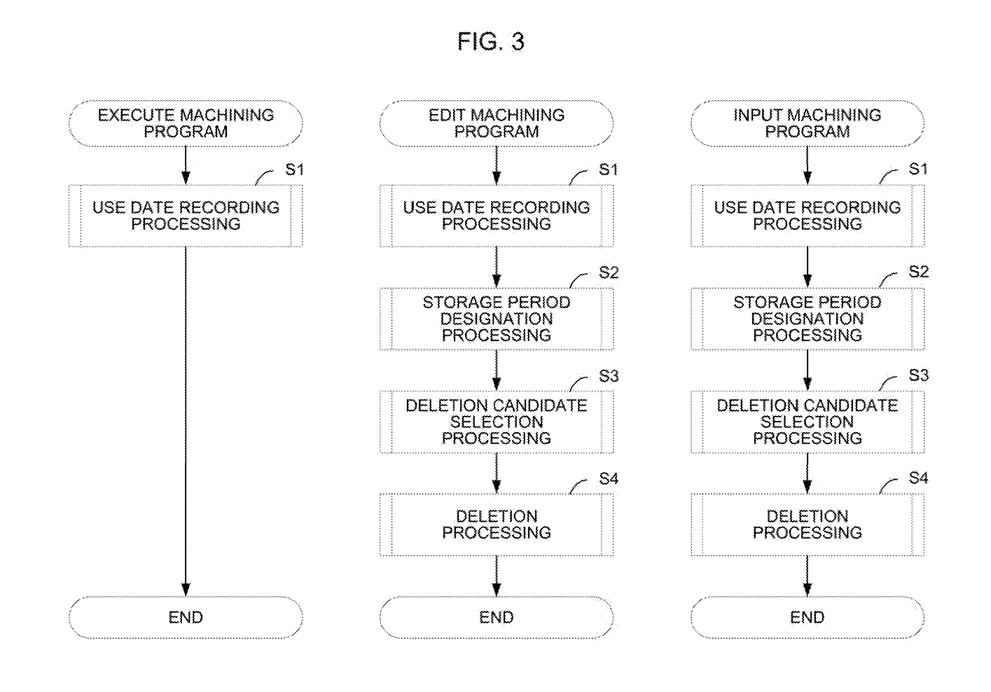

An operation of the numerical controller 100 according to the example will be described with reference to the flowchart of FIGS. 3 to 7.

FIG. 3 illustrates processing executed in each situation for executing, editing or inputting a machining program.

When a machining program is executed, the use date recording unit 120 executes use date recording processing (S1) . When the machining program is edited and inputted, the use date recording unit 120 executes the use date recording processing (S1), the storage period designating unit 110 executes storage period designation processing (S2), the deletion candidate selecting unit 130 executes deletion candidate selection processing (S3), and finally, the deleting unit 140 executes deletion processing (S5).

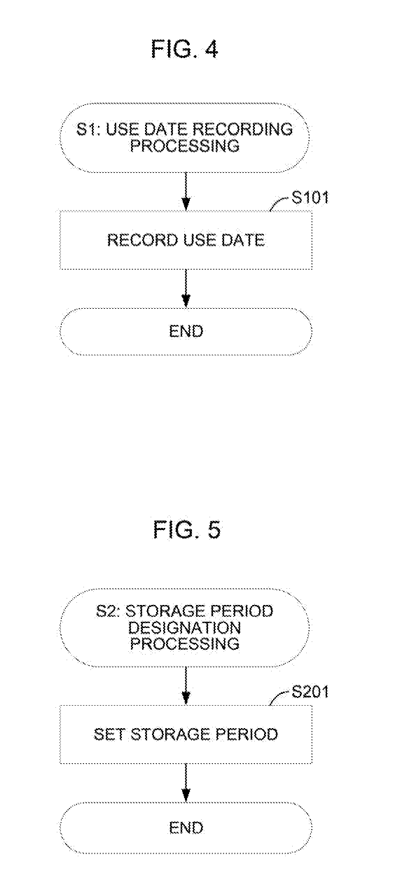

FIG. 4 illustrates contents of the use date recording processing (S1).

The use date recording unit 120 records a date on which a machining program is executed, edited or inputted (S101). More specifically, the use date recording unit 120 associates the machining program with a uniquely identifiable program number, and stores a date on which the machining program is executed, edited or inputted as a use date in the use status management table 150. The day on which the machining program is lastly used is recorded in this example. Therefore, the use date recording unit 120 updates the use date every tine the machining program is executed, edited or inputted. In addition, when the day on which the machining program is used first, the use date recording unit 120 only needs to store the date on which the machining program is executed, edited or inputted as a use date when the use date is not set, and does not update the use date when the use date is already set.

FIG. 5 illustrates contents of the storage period designation processing (S2).

The storage period designating unit 110 accepts designation of the storage period of the edited or inputted machining program, and sets the storage period to the machining program (S201). More specifically, the storage period designating unit 110 associates the machining program with a uniquely identifiable program number, and stores the designated storage period in the use status management table 150.

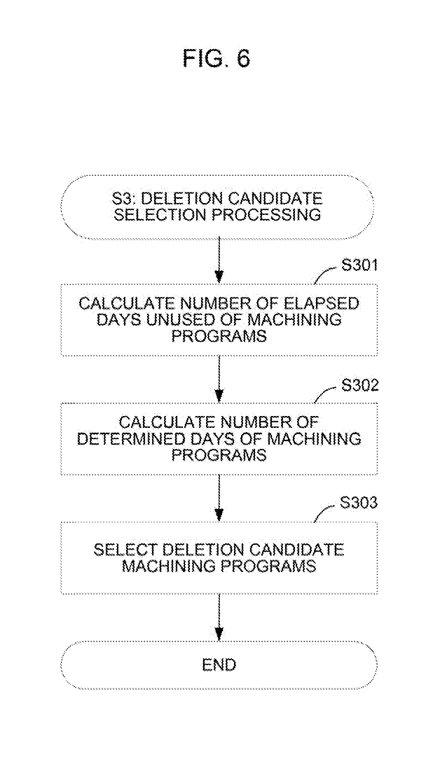

FIG. 6 illustrates contents of the deletion candidate selection processing (S3).

In this example, editing or creation of a given machining program triggers extraction of deletion candidates from all machining programs stored in a non-volatile memory. According to this method, the deletion candidates are extracted at a timing at which the machining programs accumulated in the non-volatile memory increase (i.e., the machining programs are edited or created). Consequently, it is possible to effectively restrain accumulation of unnecessary machining programs.

For the unused machining programs of all machining programs (program numbers) recorded in the use status management table 150, the deletion candidate selecting unit 130 calculates the numbers of elapsed days where the machining program has been kept unused (the number of elapsed days unused) (S301). The number of elapsed days unused can be calculated according to following equation (1).

The number of elapsed days unused=current date−use date (1)

Next, for all the machining programs (program numbers) recorded in the use status management table 150 (S302), the deletion candidate selecting unit 130 calculates the decided numbers of days. The decided number of days can be calculated according to following equation (2).

The number of determined days=the number of elapsed days unused−storage period (2)

Next, the deletion candidate selecting unit 130 extracts machining programs whose number of determined days is positive and outputs the machining programs to the deletion candidate list 160 (S303). Preferably, the deletion candidate selecting unit 130 rearranges the extracted machining programs in descending order of the number of determined days to generate the deletion candidate list 160.

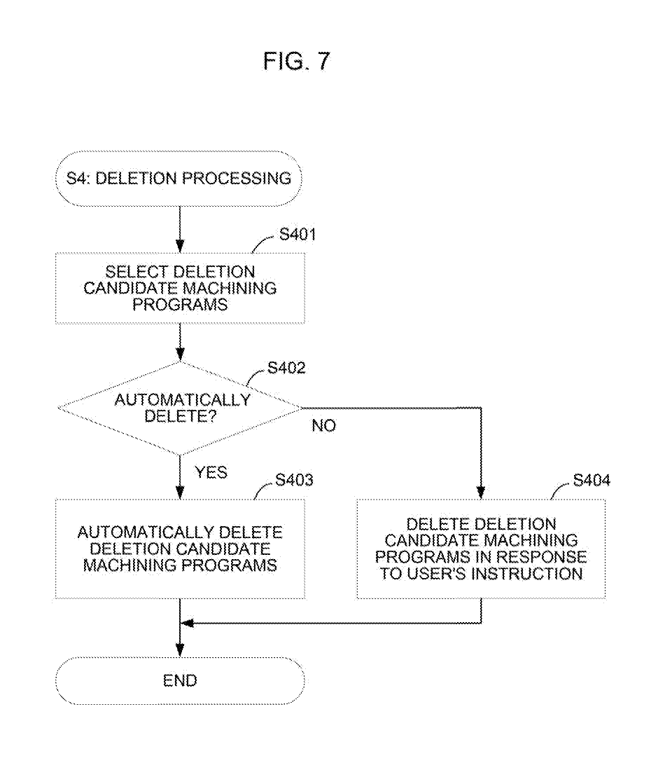

FIG. 7 illustrates contents of the deletion processing (S5).

The deleting unit 140 obtains the deletion candidate list 160 generated in S303 (S401). For example, the deleting unit 140 holds a lower limit of an empty space of the non-volatile memory in advance, and, when the current empty space of the non-volatile memory goes below the lower limit, can select a quantity of machining programs which are necessary to realize the lower limit as deletion targets from the deletion candidate list 160. In this case, the deletion candidate list 160 preferably holds information related to sizes of the machining programs as illustrated in FIG. 2. Consequently, the deleting unit 140 can select the machining programs which need to be selected as the deletion targets based on the sizes of the machining programs. In this case, the deleting unit 140 can select the machining programs in descending order of the number of determined days.

In addition, a method for selecting deletion targets described in this example is an exemplary method, and the deleting unit 140 can determine deletion targets by any other methods. For example, the deleting unit 140 may select all machining programs included in the deletion candidate list 160 as deletion targets.

When an automatic deletion function is enabled (S402), the deleting unit 140 deletes the machining programs selected as the deletion candidates in S401 from the non-volatile memory (S403). When the automatic deletion function is disenabled (S402), the deleting unit 140 presents the machining programs selected as the deletion candidates in S401 to the user. When the user permits deletion, the deleting unit 140 deletes the deletion candidate machining programs from the non-volatile memory (S404).

According to the present embodiment, the numerical controller 100 automatically extracts machining programs which are no longer used among the machining programs stored in the non-volatile memory as deletion candidates. Consequently, it is possible to reduce a user's effort to find unnecessary machining programs.

Furthermore, the numerical controller 100 deletes the deletion candidate machining programs automatically or in response to a predetermined trigger. Consequently, it is possible to prevent unnecessary machining programs from being accumulated in the non-volatile memory, and efficiently use the non-volatile memory.

The embodiments according to the present invention have been described above. However, the present invention is not limited only to the above embodiments and examples and can be carried out in various modes by adding optional changes. For example, in the above example, storage periods and use dates of machining program are calculated in units of days. However, the present invention is not limited to this, and the storage periods and the use dates may be naturally calculated in any units such as units of times, units of weeks and units of months.

Furthermore, according to the above embodiment, each processing unit is realized by collaboration of software and hardware. However, the present invention is not limited this, and, for example, each processing unit may be realized entirely by hardware.

1. A numerical controller comprising:
a storage period designating unit that sets a storage period of a machining program;
a use date recording unit that records a date on which the machining program is used;
a deletion candidate selecting unit that extracts the machining program of a deletion candidate based on the storage period and the date on which the machining program is used; and
a deleting unit that deletes the machining program of the deletion candidate.

2. The numerical controller according to claim 1, wherein the date on which the machining program is used is a date on which the machining program is lastly inputted, edited or executed.

3. The numerical controller according to claim 1, wherein the date on which the machining program is used is a date on which the machining program is inputted, edited or executed first.

4. The numerical controller according to claim 1, wherein the deletion candidate selecting unit extracts the machining program of the deletion candidate when the machining program is newly inputted or edited.
